(19) United States
(12) Patent Application Publication
(10) Pub. No.: US 2006/0213610 A1
(43) Pub. Date: Sep. 28, 2006

(54) Method and apparatus for applying a cast finish to a printed substrate

(76) Inventors: Ryan McDonnell, Chadds Ford, PA (US); Clarence Miller, Paris (CA); Eric Wu, Taipei (TW)

Correspondence Address: LITMAN LAW OFFICES, LTD, PO BOX 15035, CRYSTAL CITY STATION, ARLINGTON, VA, 22215, US

(21) Appl. No.: 11/087,640

(22) Filed: Mar. 24, 2005

(51) Int. Cl. B32B 37/00; B32B 38/10; B32B 38/00

(52) U.S. Cl. 156/275.5; 156/247; 156/272.2; 156/379.6; 156/379.8

(57) ABSTRACT

The method for applying a cast finish to a printed substrate is a method for applying aesthetically pleasing coatings and finishes, including embossed, gloss and holographic finishes and images, to flexible printed substrates, such as packaging, posters, etc. The method involves sealing the ink on a printed surface of the printed substrate with a coating, laminating a film onto the printed surface of the printed substrate, curing the printed surface of the printed substrate with ultraviolet lighting, removing the transparent film from the printed surface of the printed substrate, and moving the printed substrate to a stacking unit. A machine for carrying out the process includes a coating unit, a laminating unit, a film handling unit, a series of ultraviolet lights for curing the coating, a stacking unit for retaining the coated substrates, and a series of belts and rollers for moving the substrates through the machine.

### BACKGROUND OF THE INVENTION

1. Field of the Invention

The present invention relates to graphic arts and converting materials, and particularly to a method and apparatus for casting finish to a printed substrate.

2. Description of the Related Art

Coatings are used extensively by the graphic arts printing industry to protect and enhance products. The graphic arts printing industry and its packaging segment commonly apply coatings and other finishes to aesthetically and protectively improve printed materials and substrates, including business cards, catalogues, brochures, posters, publication covers, folding cartons, blister cards, shrink wrap films, and labels. Merchandisers are seeking a product that appeals to the consumer with a unique design and graphic appearance that differentiates their product from the rest.

Holographic and other surface finishing techniques are used throughout the graphic arts and converted industries to create flexible substrates and materials with a unique and distinctive look. Due to the mechanical application techniques involved, all graphic arts coatings and finishes, including mirror, textured, and holographic finishes, are apt to vary in the quality of the finished product. Oftentimes, in order to perform such coatings and finishes, a printed substrate must be removed from the printing press where the ink was applied and placed in separate machines that perform the duties of coating, ultraviolet curing, and the like. This results in a variation in appearance and an inconsistent look being presented to the purchasing consumer, who is attracted to the sales appeal of an aesthetically appealing finished printed product. What is needed is a process for applying aesthetically pleasing coatings and finishes, including holographic or reflective looking finishes, to printed substrates. It is also desired that these coatings and finishes be applied to the printed substrate by a single machine that is capable of being connected in series with an existing printing press.

Thus, a method and apparatus for applying a cast finish to a printed substrate solving the aforementioned problems is desired.

### SUMMARY OF THE INVENTION

The method for applying a cast finish to a printed substrate includes the steps of sealing the ink on a printed surface of the printed substrate with a coating to form a coated surface, laminating a film onto the coated surface of the printed substrate, curing the coated surface of the printed substrate with ultraviolet lighting through the film, removing the film from the coated surface of the printed substrate, and moving the substrate to a stacking unit. If a spot effect is desired, the sealing step can be replaced with the step of spot sealing the ink on the printed surface of the printed substrate with a coating.

Generally, the film used to create the finish on the substrate will be a transparent film. However, the finish can be altered by changing or altering the film itself. If an embossed effect is desired, a film with an embossed design can be used. Likewise, if a gloss effect is desired, a gloss film can be substituted. Also, if a holographic or reflective finish is desired, a holographic film or a film with a holographic image or design can be laminated onto the coated surface of the printed substrate.

A machine for performing the steps of the method for applying a cast finish to a printed substrate includes a coating unit for sealing the ink on the printed surface of the printed substrate with a coating to form a coated surface; a laminating unit for laminating the printed substrate with the film; a film handling unit for retaining, unwinding, and rewinding a roll of film; a series of ultraviolet lights for curing the coated surface of the printed substrate with ultraviolet lighting; a stacking unit for retaining the printed substrate; and a series of belts and rollers for moving the printed substrate through the machine. The machine can be a roll-fed or sheet-fed type machine and is manufactured to attach to an existing printing or coating press such that the process all takes place inline.

The finish or finished image that is applied to the printed substrate can be varied by altering the appearance of the film itself. Thus, when the film is laminated against the coated surface of the printed substrate and cured with the ultraviolet light, the resulting finish or decorative image is cast by the film onto the printed substrate. Once the substrate is cured, the film may be peeled away, rewound, and used four more times on successive substrates.

These and other features of the present invention will become readily apparent upon further review of the following specification and drawings.

### BRIEF DESCRIPTION OF THE DRAWINGS

FIG. 1 is a flowchart showing the steps of a method for applying a cast finish to a printed substrate according to the present invention.

FIG. 2 is a side view, partially in section, of an embodiment of an apparatus for applying a cast finish to a printed substrate according to the present invention.

Similar reference characters denote corresponding features consistently throughout the attached drawings.

### DETAILED DESCRIPTION OF THE PREFERRED EMBODIMENTS

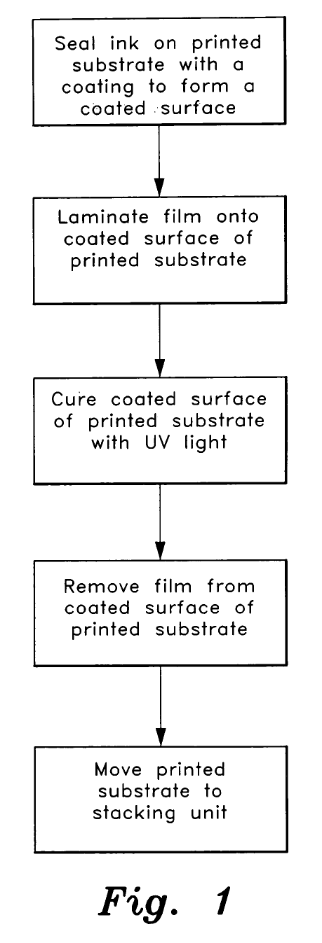

The present invention includes a method for applying a cast finish to a printed substrate, and is best illustrated by the process shown in the flowchart of FIG. 1.

Finishes, including embossed, gloss, and holographic finishes, are used throughout the graphic arts printing industry to create printed materials with a unique and distinctive look. All graphic arts coatings and finishes, due to the mechanical application techniques involved, are apt to vary in the quality of the finished product. The present invention offers a new method and apparatus by which the graphic arts printing industry may include finishes and decorative design images on common printed substrates, thereby providing a consistently high quality and visually aesthetic finished product.

As shown in FIG. 1, the process begins by sealing the ink that has been printed onto a substrate with a coating process to form a coated surface. The coating process can include coating the printed substrate with a UV coating or any other radiation type coating process that is accepted in the industry. The printed substrate is a printed material that has completed the printing process in a standard printing press.

The next step involves laminating a film onto a coated surface of the printed substrate. The film is cast such that the entire printed surface of the substrate is covered by a layer of film. Depending on the desired finish, different films can be used, including transparent film, gloss film, holographic film, or any such film with an embossed design. Next, ultraviolet light is used to cure the coated surface of the printed substrate. The ultraviolet light is applied to the coated surface while the film is laminated on top of it, resulting in the desired finish or design image being fixed on the printed substrate. After the ultraviolet curing has been finished, the film is removed from the surface of the printed substrate and the finished substrate is moved to a stacking unit. The stacking unit is where all of the completed substrates are collected after the process has been applied.

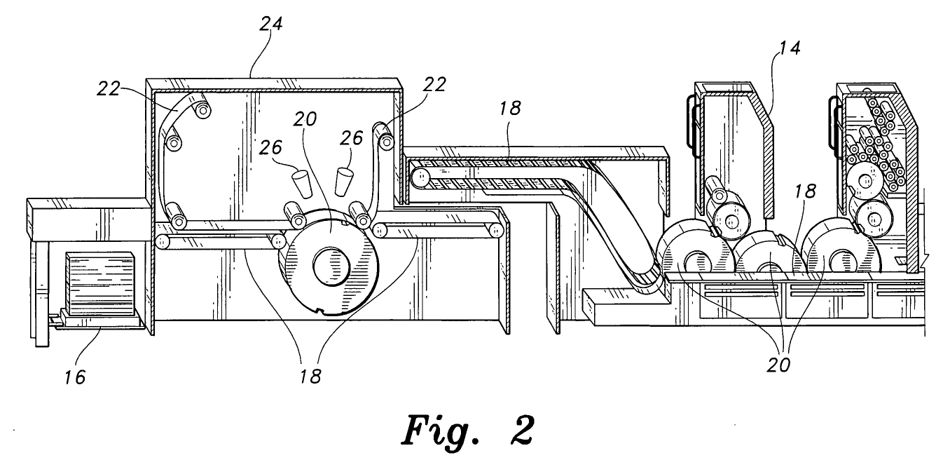

FIG. 2 shows an embodiment of an apparatus that may be used to carry out the method for applying a cast finish to a printed substrate. The apparatus is a machine that includes a coating unit 14 for sealing the ink on the printed surface of the printed substrate with a coating, a laminating unit 24 for laminating the printed substrate with the film, a film handling unit 22 for retaining, unwinding, and rewinding the film, a series of ultraviolet lamps 26 for curing the printed surface of the printed substrate with ultraviolet lighting, a stacking unit 16 for retaining the printed substrate, and a series of belts 18 and rollers 20 for moving the printed substrate through the machine. The machine is a roll-fed or sheet-fed type machine that is designed to be attached to a standard printing or coating press, allowing all of the steps of the present invention to occur inline with the printing process itself. The machine can be designed to retrofit any and all of the printing presses that are currently being used in the industry.

It will be understood that the term “substrate” as used herein refers to plastic, paper, cardboard, metal, or any other flexible material utilized by those in the graphic arts printing industry.

It is to be understood that the present invention is not limited to the embodiments described above, but encompasses any and all embodiments within the scope of the following claims.

We claim:

1. A method for applying a cast finish to a printed substrate, comprising the steps of:
sealing the ink on a printed surface of the printed substrate with a coating to form a coated surface;
laminating a film onto the coated surface of the printed substrate;
curing the coated surface of the printed substrate with ultraviolet lighting;
removing the film from the coated surface of the printed substrate; and
moving the substrate to a stacking unit.

2. The method for applying a cast finish to a printed substrate according to claim 1, wherein sealing the ink on the printed surface of the printed substrate is done with a spot sealing.

3. The method for applying a cast finish to a printed substrate according to claim 1, wherein the film is a transparent film.

4. The method for applying a cast finish to a printed substrate according to claim 1, wherein the film is a holographic film.

5. The method for applying a cast finish to a printed substrate according to claim 1, wherein the film is at least partially embossed with a decorative design.

6. The method for applying a cast finish to a printed substrate according to claim 1, wherein the film is a gloss film.

7. The method for applying a cast finish to a printed substrate according to claim 1, which comprises performing the steps with a machine having:
a coating unit for sealing the ink on the printed surface of the printed substrate with a coating to form a coated surface;
a laminating unit for laminating the printed substrate with the film;
a film handling unit for retaining, unwinding, and rewinding the film;
a series of ultraviolet lights for curing the coated surface of the printed substrate with ultraviolet lighting;
a stacking unit for retaining the printed substrate; and
a series of belts and rollers for moving the substrate through the machine.

8. A method for applying a holographic finish to a printed substrate, comprising the steps of:
sealing the ink on a printed surface of the printed substrate with a coating to form a coated surface;
laminating a holographic film onto the coated surface of the printed substrate;
curing the coated surface of the printed substrate with ultraviolet lighting;
removing the holographic film from the coated surface of the printed substrate; and
moving the substrate to a stacking unit.

9. The method for applying a holographic finish to a printed substrate according to claim 8, which comprises performing the steps with a machine having:
a coating unit for sealing the ink on the printed surface of the printed substrate with a coating to form a coated surface;
a laminating unit for laminating the printed substrate with the holographic film;
a film handling unit for retaining, unwinding, and rewinding the roll of holographic film;
a series of ultraviolet lights for curing the coated surface of the printed substrate with ultraviolet lighting;
a stacking unit for retaining the substrate; and
a series of belts and rollers for moving the substrate through the machine.

10. The method for applying a cast finish to a printed substrate according to claim 8, wherein the holographic film is at least partially embossed with a decorative design.

11. The method for applying a cast finish to a printed substrate according to claim 8, wherein sealing the ink on the printed surface of the printed substrate is done with a spot sealing.

12. A machine for applying a cast finish to a printed substrate, comprising:
a coating unit for sealing ink on a printed surface of a printed substrate with a coating to form a coated surface;
a laminating unit for laminating the coated surface of the printed substrate with film;
a film handling unit for retaining, unwinding, and rewinding the film;
a plurality of ultraviolet lights for curing the coated surface of the printed substrate with ultraviolet lighting;
a stacking unit for retaining the substrate; and
a plurality of belts and rollers for moving the substrate through the machine.
